(19) United States
(12) Patent Application Publication
(10) Pub. No.: US 2017/0218180 A1
(43) Pub. Date: Aug. 3, 2017

(54) RUBBER COMPOUND WITH A HIGH IMPERMEABILITY TO OXYGEN FOR TYRE PORTIONS

(71) Applicants: Josè Antonio SILICANI, Grottaferrata (IT); Valeria GRENCI, Roma (IT)

(72) Inventors: Josè Antonio SILICANI, Grottaferrata (IT); Valeria GRENCI, Roma (IT)

(73) Assignee: BRIDGESTONE CORPORATION, Tokyo (JP)

(21) Appl. No.: 15/123,423

(22) PCT Filed: Mar. 5, 2015
(86) PCT No.: PCT/IB2015/051620

§ 371 Date: Sep. 2, 2016

(30) Foreign Application Priority Data
Mar. 5, 2014 (IT) RM2014A000104

(51) Int. Cl. C08K 9/04; C08L 23/28; C08K 3/34

(52) U.S. Cl. CPC C08K 9/04; C08K 3/346; C08L 23/283

(57) ABSTRACT

A compound to prepare a tyre portion comprising a polymer base with cross-linking unsaturated chain comprising at least one halobutyl rubber, a reinforcing filler, a vulcanization system and a reinforcing filler with a laminated structure pretreated with a treating agent comprised in the group consisting of fatty acids, resin acid, fatty acid salts and fatty acid esters.

### TECHNICAL FIELD

The present invention relates to rubber compounds with a high impermeability to oxygen for tyre portions.

### BACKGROUND ART

In the manufacture of tyres it is necessary to produce some portions characterised by a high impermeability to oxygen.

One of these portions is the inner liner, which consists of an internal layer of rubber used in tubeless tyres, i.e. those without an inner tube, in order to ensure that the air contained in the carcass remains pressurized. The inner liner must also ensure that the oxygen remains confined as much as possible within the carcass and is not diffused to the other portions of the tyre causing phenomena of degradation thereof.

In order to obtain a tyre with increasingly high rolling resistance, there is the need to produce an inner liner with increasingly reduced thickness, without this impairing its performance in terms of impermeability. In fact, a thinner inner liner necessarily translates into a smaller quantity of material used and, therefore, a lower weight of the tyre itself, with positive effects on the global energy consumption of the vehicle and on the rolling resistance. From the above, it is understood that a reduction in the thickness of the inner liner is only possible if a high impermeability can be imparted thereto.

The portions with a high impermeability to oxygen are usually made with a halobutyl rubber, but to satisfy the physical characteristics required for a tyre compound, it might be advantageous to use another rubber, such as natural rubber, together with the halobutyl rubber. However, it has been determined experimentally that the use of a polymer base mixture can cause uneven dispersion of the ingredients of the compound, with consequences in terms of physical properties known to those skilled in the art.

Therefore, there was the need to produce a compound for tyre portions, whose technical characteristics were such as to impart a high impermeability to oxygen and, simultaneously, allow the use of a polymer base mixture without compromising the homogeneous dispersion of the ingredients in the compound.

### DISCLOSURE OF INVENTION

The object of the present invention is a compound to prepare a tyre portion; said compound comprising a polymer base with a cross-linking unsaturated chain comprising at least an halobutyl rubber, a reinforcing filler and a vulcanization system; said compound being characterised in that it comprises a reinforcing filler with a laminated structure pretreated with a treating agent comprised in the group consisting of fatty acids, resin acids, fatty acid salts and fatty acid esters; said reinforcing filler with a laminated structure being pretreated with a quantity of treating agent ranging from 50 to 100 parts by weight per 100 parts by weight of filler with laminated structure.

Here and hereunder, the vulcanization system is intended as a group of ingredients comprising at least sulphur and accelerators that, in the preparation of the compound, are added in a final mixing step, and have the purpose of promoting vulcanization of the polymer base when the compound is subjected to a vulcanization temperature.

Here and hereunder, the reinforcing filler with a laminated structure pretreated with fatty acids is intended as a reinforcing filler with a laminated structure mixed with the fatty acids according to a method so as to produce a chemical/physical interaction between the chains of the fatty acids and the reinforcing filler. A possible method concerns cold mixing of the reinforcing filler with the fatty acids and subsequent heating of the mixture formed.

Preferably, the compound comprises from 2 to 70 phr, even more preferably, from 2 to 20 phr, of said pretreated reinforcing filler with a laminated structure.

Preferably, the reinforcing filler with a laminated structure is comprised in the group consisting of argillaceous materials, talc, phyllosilicates, materials belonging to the mica group, graphite, and graphene.

Preferably, the reinforcing filler with a laminated structure is pretreated with a quantity of treating agent ranging from 70 to 100 parts by weight per 100 parts by weight of filler with laminated structure.

Preferably, the reinforcing filler with a laminated structure is pretreated with treating agent comprising a chain of carbon atoms ranging in number from 16 to 24.

Preferably, the polymer base with cross-linking unsaturated chain comprises a polymer mixture consisting at least of the halobutyl rubber and natural rubber.

Preferably, polymer mixture is made up of 60-90 phr of halobutyl rubber and 10-40 phr of natural rubber.

A further object of the present invention is a tyre portion produced with a compound according to the present invention.

Preferably, the tyre portion is an inner liner.

A further object of the present invention is a tyre comprising a portion as defined above.

One more object of the present invention is a use, in rubber compounds for the preparation of tyre portions, of a reinforcing filler with a laminated structure pretreated with a treating agent comprised in the group consisting of fatty acids, resin acids, fatty acid salts and fatty acid esters.

### BEST MODE FOR CARRYING OUT THE INVENTION

For a better understanding of the present invention, some examples, provided purely for non-limiting, illustrative purposes, are indicated below.

### EXAMPLES

Five compounds according to the present invention (A-E) and five control compounds (Cont. 1-Cont. 5) were produced. The five compounds according to the present invention are distinguished from one another based on the composition of the polymer base and on the quantity of fatty acids used for pretreatment of the reinforcing filler with a laminated structure.

The five control compounds are compounds in which the reinforcing filler with a laminated structure pretreated with fatty acids is not present (Cont. 1-Cont. 3) and compounds comprising the reinforcing filler with a laminated structure pretreated with a quantity of fatty acids below the quantity established in the present invention (Cont. 4 and Cont. 5).

The process for preparation of the compounds described in the examples is indicated below. This process is not a limitation for the present invention.

pretreating the reinforcing filler with a laminated structure with fatty acids

Clay was mixed with a quantity of stearic acid according to the proportions indicated in the compositions of Tables I and II.

The mixture obtained was maintained at a temperature of 100° C. for one hour, after which it was left to cool and ground to be used in a compound.

### Preparation of the Compounds

### (1^{st} Mixing Step)

The ingredients indicated in Tables I and II, with the exclusion of the vulcanization system, were loaded into a mixer with tangential rotors with an inner volume of from 230 to 270 litres before starting to mix, reaching a filling factor of 66-72%.

The mixer was operated at a speed of 40-60 rpm, and the mixture formed was unloaded after reaching a temperature of 140-160° C.

### (2^{nd} Mixing Step)

The mixture thus produced was once again processed in the mixer operated at a speed of 40-60 rpm. Subsequently, the compound was unloaded after reaching a temperature of 130-150° C.

### (Final Mixing Step)

The vulcanization system was added to the mixture obtained in the previous mixing step, reaching a filling factor of 63-67%. The mixer was operated at a speed of 20-40 rpm, and the mixture formed was unloaded after reaching a temperature of 100-110° C.

Table I indicates the compositions in phr of the compounds according to the invention.

TABLE I

| | A | B | C | D | E |
|---|---|---|---|---|---|
| Natural rubber | — | 10 | 20 | 20 | 20 |
| Br-IIR | 100 | 90 | 80 | 80 | 80 |
| Clay pretreated with | 20 | 20 | 20 | 20 | 20 |
| stearic acid* | | | | | |

| | |
|---|---|
| Carbon black | 7 |
| ZnO | 3 |
| Sulphur | 0.5 |
| Accelerator | 1 |

*for compounds A-C the clay was pretreated with 80 parts by weight of stearic acid per 100 parts by weight of clay; for the compounds D and E the clay was pretreated respectively with 100 and 50 parts by weight of stearic acid per 100 parts by weight of clay.

Br-IIR stands for brominated butyl rubber

The Carbon Black used is classified with the code N660.

The accelerator used was mercaptobenzothiazole disulphide (MBTS).

Table II indicates the compositions in phr of the control compounds.

TABLE II

| | Cont. 1 | Cont. 2 | Cont. 3 | Cont. 4 | Cont. 5 |
|---|---|---|---|---|---|
| Natural rubber | — | 10 | 20 | 20 | 20 |
| Br-IIR | 100 | 90 | 80 | 80 | 80 |
| Clay pretreated with | — | — | — | 20 | 20 |
| stearic acid** | | | | | |

| | |
|---|---|
| Carbon black | 7 |
| ZnO | 3 |
| Sulphur | 0.5 |
| Accelerator | 1 |

**for compounds Cont. 4 and Cont. 5, the clay was pretreated respectively with 30 and 10 parts by weight of stearic acid per 100 parts by weight of clay.

The specifications of the ingredients are the same as those indicated for Table I.

The compounds of the examples were subjected to a series of tests to check the physical characteristics and impermeability. The physical characteristics in particular related to resistance to the propagation of cracks, formation of cracks at low temperature and green strength.

The impermeability to oxygen test was performed on materials with a thickness of 0.7 mm and using a conventional apparatus, such as the MOCON®OX-TRA®(model 2/61). The measurements were taken at a temperature of 25° C.

The test for resistance to crack formation at low temperature was performed in accordance with the standard ISO 4664-1 at a temperature of −40° C.

The test for resistance to crack propagation was performed in accordance with the standard ISO 27727 (using the TEAR ANALYZER) at a temperature of 40° C.

The green strength test was performed in accordance with the standard ASTM D5279 at a temperature of 25° C. and a frequency of 50 Hz.

Tables III and IV indicate the results obtained from the tests above. In Tables III and IV the test results are expressed with values indexed to the results of the control compound Cont. 1.

The higher the values relating to impermeability to oxygen, crack propagation and green strength, the better the evaluation of the related characteristic is; vice versa, the lower the values relating to crack formation at low temperature, the better the evaluation of the characteristic is.

TABLE III

| | A | B | C | D | E |
|---|---|---|---|---|---|
| Resistance to crack | 105 | 115 | 120 | 120 | 115 |
| propagation | | | | | |
| Green strength | 105 | 108 | 115 | 115 | 110 |
| Crack formation at low | 96 | 88 | 80 | 80 | 79 |
| temperature | | | | | |
| Impermeability to oxygen | 120 | 110 | 105 | 105 | 95 |

TABLE IV

| | Cont. 1 | Cont. 2 | Cont. 3 | Cont. 4 | Cont. 5 |
|---|---|---|---|---|---|
| Resistance to crack | 100 | 105 | 110 | 112 | 110 |
| propagation | | | | | |
| Green strength | 100 | 105 | 109 | 109 | 109 |
| Crack formation at | 100 | 92 | 84 | 83 | 84 |
| low temperature | | | | | |
| Impermeability to | 100 | 90 | 80 | 93 | 85 |
| oxygen | | | | | |

As can be seen clearly from comparing the values indicated in Tables III and IV, the solution of the present invention is able to guarantee an improvement in terms of impermeability to oxygen and, simultaneously, an improvement of the physical characteristics, which denotes a homogeneous dispersion of the ingredients in the compound.

By analysing the results relating to the control compounds Cont.4 and Cont.5 it can be seen how the quantity of fatty acids involved in pretreatment of the reinforcing filler with a laminated structure is a mandatory characteristic of the present invention. In fact, the values of Table IV show that if a quantity of fatty acids below the range claimed is used in pretreatment of the reinforcing filler with a laminated structure, the improvements in terms of impermeability to oxygen and physical characteristics are not obtained. Vice versa, if a quantity of fatty acids greater than the quantity claimed is used, the processability of the pretreated reinforcing filler is compromised, without any further improvement of the impermeability to oxygen and of the physical characteristics.

1-17. (canceled)

18. A compound to prepare a tyre portion; said compound comprising a polymer base with cross-linking unsaturated chain comprising at least one halobutyl rubber, a reinforcing filler, and a vulcanization system; said compound being characterised in that it comprises a reinforcing filler with a laminated structure pretreated with a treating agent comprised in the group consisting of fatty acids, resin acid, fatty acid salts and fatty acid esters; said reinforcing filler with a laminated structure being pretreated with a quantity of treating agent ranging from 50 to 100 parts by weight per 100 parts by weight of filler with laminated structure.

19. A compound according to claim 18, characterised in that it comprises 2 to 70 phr of said reinforcing filler with a laminated structure pretreated.

20. A compound according to claim 18, characterised in that it comprises 2 to 20 phr of said reinforcing filler with a laminated structure pretreated.

21. A compound according to claim 18, characterised in that said reinforcing filler with a laminated structure is comprised in the group consisting of argillaceous materials, talc, phyllosilicates, materials belonging to the mica group, graphite, and graphene.

22. A compound according to claim 18, characterised in that said reinforcing filler with a laminated structure is pretreated with a quantity of treating agent ranging from 70 to 100 parts by weight per 100 parts by weight of filler with laminated structure.

23. A compound according to claim 18, characterised in that said reinforcing filler with a laminated structure is pretreated with treating agent comprising a chain of carbon atoms ranging in number from 16 to 24.

24. A compound according to claim 18, characterised in that said polymer base with cross-linking unsaturated chain comprises a polymer mixture comprising at least of said halobutyl rubber and of natural rubber.

25. A compound according to claim 18, characterised in that said polymer mixture is made up of 60-90 phr of halobutyl rubber and 10-40 phr of natural rubber.

26. A tyre portion manufactured with a compound according to claim 18.

27. A tyre portion according to claim 26, characterised in that it is an inner liner.

28. A tyre comprising a portion according to claim 26.

29. A use, in rubber compounds for the preparation of tyre portions, of a reinforcing filler with a laminated structure pretreated with a treating agent comprised in the group consisting of fatty acids, resin acid, fatty acid salts and fatty acid esters.

30. A use according to claim 29, characterised in that said reinforcing filler with a laminated structure is pretreated with a quantity of treating agent ranging from 50 to 100 parts by weight per 100 parts by weight of filler with laminated structure.

31. A use according to claim 29, characterised in that said reinforcing filler with a laminated structure is comprised in the group consisting of argillaceous materials, talc, phyllosilicates, materials belonging to the mica group, graphite, and graphene.

32. A use according to claim 29, characterised in that said reinforcing filler with a laminated structure is pretreated with a quantity of treating agent ranging from 70 to 100 parts by weight per 100 parts by weight of filler with laminated structure.

33. A use according to claim 29, characterised in that said reinforcing filler with a laminated structure is pretreated with a treating agent comprising a chain of carbon atoms ranging in number from 16 to 24.
